(19) United States
(12) Patent Application Publication
(10) Pub. No.: US 2026/0172591 A1
(43) Pub. Date: Jun. 18, 2026

(54) MOTION VECTOR REFINEMENT AND DERIVATION

(71) Applicant: Alibaba (China) Co., Ltd., Hangzhou (CN)

(72) Inventors: Li YU, Wuhan (CN); Hongbo LI, Wuhan (CN); Jiabao ZHU, Wuhan (CN); Yucheng ZHONG, Wuhan (CN); Jie Chen, Beijing (CN); Ru-ling Liao, Sunnyvale, CA (US); Yan Ye, San Diego, CA (US)

(21) Appl. No.: 19/390,561

(22) Filed: Nov. 15, 2025

Related U.S. Application Data
(60) Provisional application No. 63/733,992, filed on Dec. 13, 2024.
(60) Provisional application No. 63/819,290, filed on Jun. 6, 2025.

(51) Int. Cl. H04N 19/52; H04N 19/105; H04N 19/109; H04N 19/139; H04N 19/156; H04N 19/172; H04N 19/176; H04N 19/70

(52) U.S. Cl. CPC H04N 19/52; H04N 19/105; H04N 19/109; H04N 19/139; H04N 19/156; H04N 19/172; H04N 19/176; H04N 19/70

(57) ABSTRACT

An AVS3 and later-standard encoder and an AVS3 and later-standard decoder are provided, configuring one or more processors of a computing system to perform motion vector refinement in motion prediction by inter prediction in skip mode or direct mode. The encoder and the decoder are configured to implement preliminary searching before reordering motion candidates of a motion candidate list; prioritized candidate reordering and weighted candidate reordering; an Inter TM candidate list including one or more SBTMVP candidates and ETMVP candidates; TM-based refinement based on combined reference templates; conditional motion vector derivation for TMVP candidates; and converting a bi-predicted block to a uni-predicted block.

### RELATED APPLICATIONS

This application claims the benefit of U.S. Patent Application No. 63/733,992, entitled “MOTION VECTOR REFINEMENT AND DERIVATION” and filed Dec. 13, 2024, and U.S. Patent Application No. 63/819,290, entitled “MOTION VECTOR REFINEMENT AND DERIVATION” and filed Jun. 6, 2025, which are expressly incorporated herein by reference in their entirety.

### BACKGROUND

In 2016, the Audio Video coding Standard (“AVS”) workgroup published the AVS2 standard for digital audio and video series compression. This standard further improves video coding performance over prior standards such as AVS1, H.264/AVC (Advanced Video Coding) and H.265/HEVC (High Efficiency Video Coding). The AVS continues to propose additional improvements to a third generation of AVS standard, collected under the AVS3 name.

According to the AVS3 standard, an encoder and a decoder partition picture data into blocks, and perform motion prediction upon luma and chroma components of the blocks by selecting one among various intra prediction and inter prediction modes. The AVS3 standard implements uni-prediction and bi-prediction modes. AVS3 also includes template matching in the inter prediction mode.

Presently, the AVS workgroup is reviewing draft proposals for subsequent improvements over AVS3 techniques to be included in the successor AVS4 standard. There is a need to further improve the accuracy of searching for motion vectors when template matching has occurred over the functionality provided by the AVS3 standard.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, an encoding process and a decoding process according to an example embodiment of the present disclosure.

FIG. 2 illustrates an example diagram of sub-block temporal motion vector predictor derivation.

FIGS. 3A, 3B, and 3C illustrate example diagrams of a control points based affine model for motion compensation.

FIG. 4 illustrates collocated sub-blocks for candidate pruning when deriving an enhanced temporal motion vector predictor.

FIGS. 5A and 5B illustrate integer searching points and constraints for the best integer positions in decoder side motion vector refinement.

FIG. 6 illustrates an L-shaped inter prediction by template matching (“Inter TM”) template.

FIGS. 7A and 7B illustrate Inter TM hexagonal and square search points.

FIG. 8 illustrates calculating a sub-block temporal motion vector predictor template matching cost according to an example embodiment of the present disclosure.

FIG. 9 illustrates calculating an enhanced temporal motion vector predictor template matching cost according to an example embodiment of the present disclosure.

FIGS. 10A, 10B, and 10C illustrate an adjustment of temporal motion vector prediction motion vector derivation according to example embodiments of the present disclosure.

FIG. 11 illustrates combining reference templates from reference picture list 0 and reference picture list 1 when performing TM-based refinement for bi-prediction candidates.

FIG. 12 illustrates converting a bi-predicted block to a uni-predicted block, then uni-predicting all sub-blocks therein.

FIG. 13 illustrates an example system for implementing the processes and methods described herein for implementing motion vector refinement.

### DETAILED DESCRIPTION

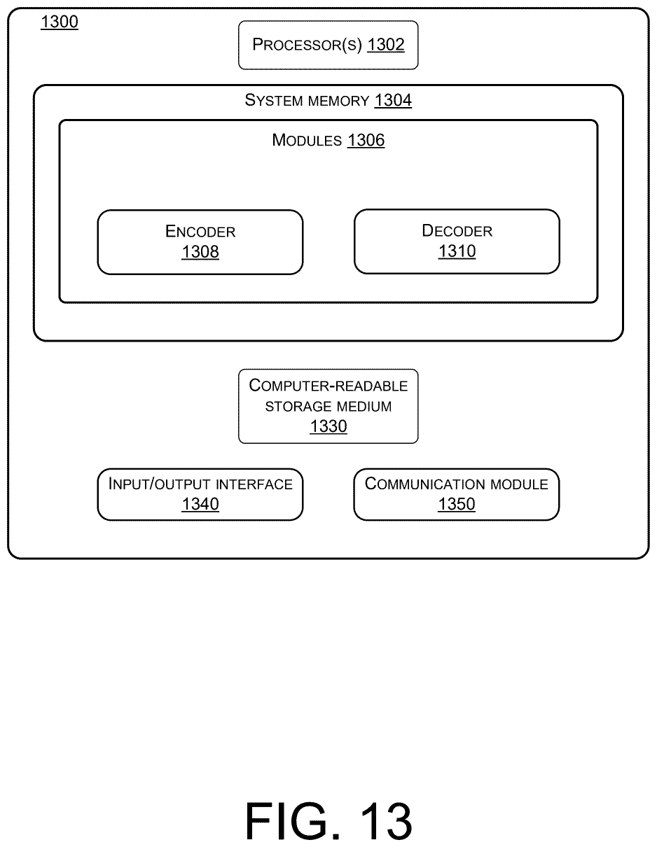

In accordance with AVS3 and later video coding standard (“AVS3 and later standard”), and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 13, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by AVS3 and later standards, and operations of a decoder as described by AVS3 and later standards. Some of these encoder operations and decoder operations according to AVS3 and later standards are subsequently described in further detail, though these subsequent descriptions should not be understood as exhaustive of encoder operations and decoder operations according to AVS3 and later standards. Subsequently, an “AVS3 and later-standard encoder,” and an “AVS3 and later-standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, an AVS3 and later-standard encoder an AVS3 and later-standard decoder further include computer-readable instructions stored on a computer-readable storage medium which are executable by one or more processors of a computing system to configure the one or more processors to perform operations not specified by AVS3 and later standards. An AVS3 and later-standard encoder should not be understood as limited to operations of a reference implementation of an encoder, but including further computer-readable instructions configuring one or more processors of a computing system to perform further operations as described herein. An AVS3 and later-standard decoder should not be understood as limited to operations of a reference implementation of a decoder, but including further computer-readable instructions configuring one or more processors of a computing system to perform further operations as described herein.

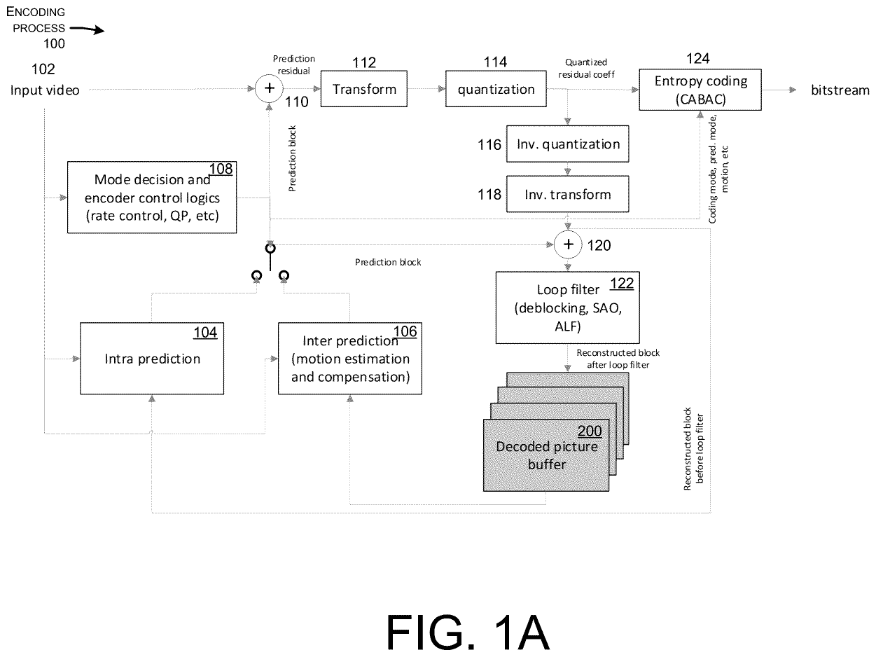

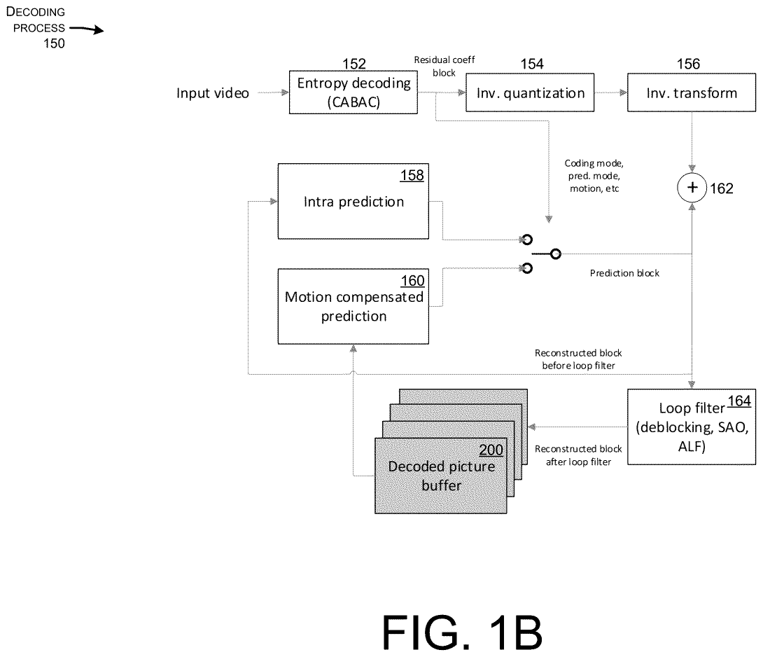

FIGS. 1A and 1B illustrate example block diagrams of, respectively, an encoding process 100 and a decoding process 150 according to an example embodiment of the present disclosure.

In an encoding process 100, an AVS3 and later-standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. An AVS3 and later-standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

An AVS3 and later-standard encoder encodes a picture (a picture being encoded being called a “current picture,” as distinguished from any other picture received from an image source 102) by configuring one or more processors of a computing system to partition the original picture into units and subunits according to a partitioning structure. An AVS3 and later-standard encoder configures one or more processors of a computing system to subdivide a picture into macroblocks (“MBs”) each having dimensions of 16×16 pixels, which can be further subdivided into partitions. An AVS3 and later-standard encoder configures one or more processors of a computing system to subdivide a picture into coding tree units (“CTUs”), the luma and chroma components of which can be further subdivided into coding tree blocks (“CTBs”) which are further subdivided into coding units (“CUs”). Alternatively, an AVS3 and later-standard encoder configures one or more processors of a computing system subdivide a picture into units of N×N pixels, which can then be further subdivided into subunits. Each of these largest subdivided units of a picture can generally be referred to as a “block” for the purpose of this disclosure.

A CU is coded using one block of luma samples and two corresponding blocks of chroma samples, where pictures are not monochrome and are coded using one coding tree.

An AVS3 and later-standard encoder configures one or more processors of a computing system to subdivide a block into partitions having dimensions in multiples of 4×4 pixels. For example, a partition of a block can have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, an AVS3 and later-standard encoder configures one or more processors of a computing system to encode color information of a picture at a lower resolution than the input picture, storing the color information in fewer bits than the input picture.

Furthermore, an AVS3 and later-standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs can refer to a unit or multiple subunits corresponding to a block structure among multiple block structures of a picture, such as an MB or a CTU, wherein blocks are partitioned based on the picture data and are coded according to AVS3 and later standards. Motion information corresponding to a PU can describe motion prediction as encoded by a AVS3 and later-standard encoder as described herein.

An AVS3 and later-standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction can further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

An AVS3 and later-standard encoder configures one or more processors of a computing system to code a CU to include reference indices to identify, for reference of an AVS3 and later-standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

An AVS3 and later-standard encoder configures one or more processors of a computing system to code each current block of a picture individually, outputting a prediction block for each. According to AVS3 and later standards, a CTU can be as large as 128×128 luma samples (plus the corresponding chroma samples, depending on the chroma format). A CTU can be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, an AVS3 and later-standard encoder configures one or more processors of a computing system to send coding parameter sets such as coding mode (i.e., intra or inter prediction), a mode of intra prediction or a mode of inter prediction, and motion information to an entropy coder 124 (as described subsequently).

AVS3 and later standards provide semantics for recording coding parameter sets for a CU. It should be understood that AVS3 and later standards include semantics for recording various information, flags, and options.

An AVS3 and later-standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

An AVS3 and later-standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, an AVS3 and later-standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients can refer to coefficients representing one of several spatial transformations, such as a diagonal flip, a vertical flip, or a rotation, which can be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above.

An AVS3 and later-standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

An AVS3 and later-standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

An AVS3 and later-standard encoder further implements an adder 120. One or more processors of a computing system are configured to perform an addition operation by adding a prediction block and a reconstructed residual, outputting a reconstructed block.

An AVS3 and later-standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

An AVS3 and later-standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

An AVS3 and later-standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

An AVS3 and later-standard encoder configures one or more processors of a computing system to output a coded picture, made up of coded blocks from the entropy coder 124. The coded picture is output to a transmission buffer, where it is ultimately packed into a bitstream for output from the AVS3 and later-standard encoder. The bitstream is written by one or more processors of a computing system to a non-transient or non-transitory computer-readable storage medium of the computing system, for transmission.

In a decoding process 150, an AVS3 and later-standard decoder configures one or more processors of a computing system to receive, as input, one or more coded pictures from a bitstream.

An AVS3 and later-standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

An AVS3 and later-standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the AVS3 and later-standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the AVS3 and later-standard decoder configures one or more processors of a computing system to perform intra prediction 158 using prediction information specified in the coding parameter sets. The intra prediction 158 thereby generates a prediction signal.

In the event that the coding parameter sets specify inter prediction, the AVS3 and later-standard decoder configures one or more processors of a computing system to perform motion compensated prediction 160 using a reference picture from a DPB 200. The motion compensated prediction 160 thereby generates a prediction signal.

An AVS3 and later-standard decoder further implements an adder 162. The adder 162 configures one or more processors of a computing system to perform an addition operation on the reconstructed residuals and the prediction signal, thereby outputting a reconstructed block.

An AVS3 and later-standard decoder further implements a loop filter 164. One or more processors of a computing system are configured to apply a loop filter, such as a deblocking filter, a SAO filter, and ALF to a reconstructed block, outputting a filtered reconstructed block.

An AVS3 and later-standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

An AVS3 and later-standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, an AVS3 and later-standard encoder and an AVS3 and later-standard decoder each implements motion prediction coding in accordance with AVS3 and later specifications. An AVS3 and later-standard encoder and an AVS3 and later-standard decoder each configures one or more processors of a computing system to generate a reconstructed picture based on a previous reconstructed picture of a DPB according to motion compensated prediction as described by AVS3 and later standards, wherein the previous reconstructed picture serves as a reference picture in motion compensated prediction as described herein.

There are multiple inter prediction modes in AVS3 and later standards, including direct mode, skip mode, and inter modes. For skip mode and direct mode, the motion information including reference index and motion vector is not signaled in the bitstream but derived at the decoder side with a same rule as encoder does. These two modes share the same motion information derivation rule, and the only difference between them is that skip mode skips the signaling of the residuals by setting residuals to be zero but direct modes still has residuals signaled in the bitstream. Compared with inter modes, the bits dedicated on the motion information can be saved in skip mode and direct mode, but the encoder has to follow the rule specified in the standard to derive the motion vector and reference index to perform inter prediction, while in inter modes the encoder can choose any allowed values for motion vector and reference index as the motion vector difference and reference index are signaled. Therefore, the skip mode and direct mode are applicable to cases where the motion information of the current block is close to that of spatial or temporal neighboring block, since the derivation of the motion information is based on the spatial or temporal neighboring block.

To derive the motion information used in inter prediction in skip mode and direct mode, an AVS3 and later-standard encoder configures one or more processors of a computing system to derive a motion candidate list and then select one of them to perform the inter prediction. The index of the selected candidate is signaled in the bitstream. An AVS3 and later-standard encoder configures one or more processors of a computing system to derive the same motion candidate list, and then use the index parsed from the bitstream to get the motion (including motion vector and reference index) used for inter prediction and then perform inter prediction.

Currently in AVS3 and later, there are 12 candidates in the normal motion candidate list, including temporal candidate (namely temporal motion vector predictor), spatial candidates (namely spatial motion vector predictor), sub-block based spatial candidate (namely motion vector angular predictor) and history based candidate (namely history based motion vector predictor).

The first such candidate in the normal motion candidate list is the temporal motion vector predictor (“TMVP”) which is derived from the MV of a collocated block in a certain reference frame. The certain reference frame here is specified as the reference frame with reference index being 0 in the list 1 for B frame or list 0 for P frame. When the MV of the collocated block is unavailable, a MV predictor (“MVP”) derived according to the MV of spatial neighboring blocks is used as a block-level TMVP candidate. AVS3 and later also adopt sub-block level TMVP (“SBTMVP”).

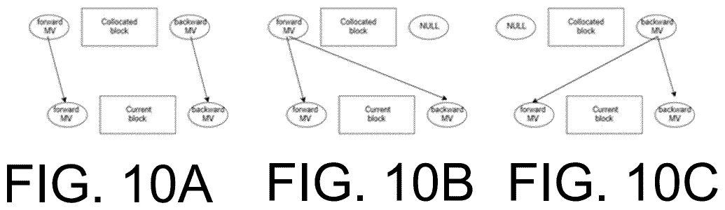

For B frames, the collated picture can be set as the first picture in reference picture list 1 of a current picture. After identifying a collocated block, a forward MV (MV of a reference picture list 0) of the collocated block can be scaled to derive both the forward and backward MVs for the current block. This can be seen illustrated in FIG. 10B. The scaling factor can be the ratio of the difference in Picture Order Count (“POC”) between the current picture and its reference frame to the difference in POC between the collocated picture and the reference picture of the collocated picture.

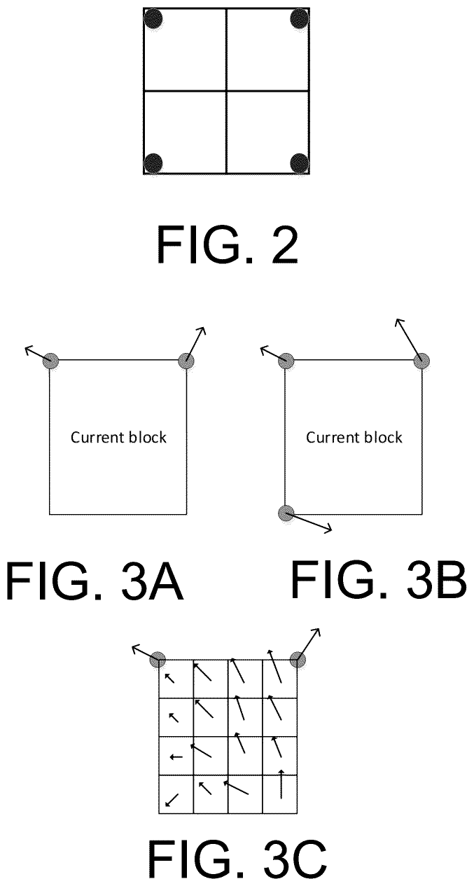

When sub-block TMVP candidates are enabled, the current block is split into four sub-blocks as illustrated in FIG. 2, and a motion vector is derived for each sub-block. As shown in FIG. 2, for each sub-block, a corner sample is used to find the collocated block in the reference picture. The motion vector stored in the temporal motion information buffer covering the sample with the same coordinator in the reference picture as the corner sample is fetched and scaled. The scaled motion vector is used as the TMVP of the each sub-block. If a list 0 motion vector in the temporal motion information buffer is available (i.e., the collocated block has a list 0 motion vector), the list 0 motion vector is used; otherwise if a list 1 motion vector is in the temporal motion information buffer is available (i.e., the collocated block does not have a list 0 motion vector but has a list 1 motion vector), the list 1 motion vector is used; otherwise, block level TMVP will be derived and used as the TMVP for the current sub-block.

Sub-block TMVP can only be used for the block whose width and height are both greater than or equal to 16.

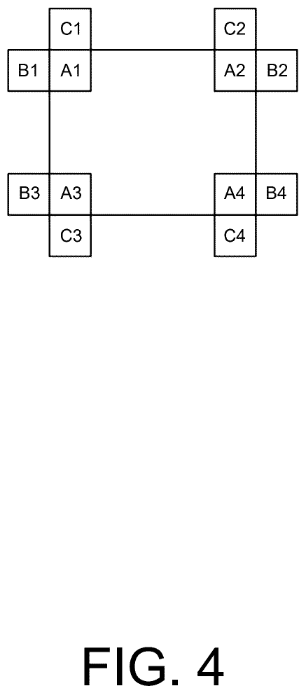

Enhanced Temporal Motion Vector Predictor (“ETMVP”) is another way to derive motion information in AVS3 and later, wherein the current block is divided into 8×8 sub-blocks and each sub-block derives a motion vector based on the corresponding temporal neighboring block motion information. When the ETMVP flag signaled in the bitstream indicates ETMVP is enabled, a motion candidate list is constructed. Each candidate in the list contains multiple motion vectors, one for each 8v8 sub-block. For the first candidate, the motion vector of each 8×8 sub-block is derived from the motion vector of the corresponding collocated block in the reference picture with reference index equal to 0 in the reference picture list 0. For the second candidate, the current block is firstly shifted down by 8 samples, and then the motion vector of each sub-block is derived from the corresponding collocated block of the shifted block in the reference picture with reference index equal to 0 in the reference picture list 0. For the third candidate, the current block is firstly shifted to the right by 8 samples, and then the motion vector of each sub-block is derived from the corresponding collocated block of the shifted block in the reference picture with reference index equal to 0 in the reference picture list 0. For the fourth candidate, the current block is firstly shifted up by 8 samples, and then the motion vector of each sub-block is derived from the corresponding collocated block of the shifted block in the reference picture with reference index equal to 0 in the reference picture list 0. For the fifth candidate, the current block is firstly shifted to the left down by 8 samples, and then the motion vector of each sub-block is derived from the corresponding collocated block of the shifted block in the reference picture with reference index equal to 0 in the reference picture list 0. The last four candidates will be pruned by comparing the motion information of two pre-defined sub-blocks in the reference picture. As in FIG. 4, for the second candidate, the motion information of A2 and C4 is compared; for the third candidate, motion information of A3 and B4 is compared; for the fourth candidate, motion information of A4 and C2 is compared; for the fifth candidate, motion information of A4 and B3 is compared. If the motion information of the two blocks is not the same, the candidate is valid and inserted into the candidate list. If the number of valid candidates is less than 5, the next candidate as listed above will be inserted until the candidate number is 5.

When deriving the motion vector for each sub-block, the list 0 motion vector of the collocated block is used to derive the list 0 motion vector of the corresponding sunblock and the list 1 motion vector of the collocated block is used to derive the list 1 motion vector of the corresponding sunblock. The reference index of list 0 and list 1 for the current sub-block are set to 0. Thus, if the collocated block is a list 0 uni-prediction block, the corresponding sub-block also uses list 0 uni-prediction; if the collocated block is a list 1 uni-prediction block, the corresponding sub-block also uses list 1 uni-prediction picture; if the collocated block is a bi-prediction block, the corresponding sub-block also uses bi-prediction; if the collocated block is an intra block, the motion vector of the corresponding sub-block is set to a default motion vector which is derived from the spatial neighboring block.

After a motion candidate list is constructed, a candidate index signaled in a bitstream identifies a motion candidate by ordering of the motion candidate list.

The MV represents object motion between two pictures at different time instances. However, it can only represent translational motion, as all the samples in the block have the same position shift. To compensate for other kinds of motion, such as zoom in/out and rotation, affine model based motion compensation is adopted in AVS3 and later. In affine model based motion compensation, different samples in the block have different motion vectors. Also, the motion vector of each sample is derived from the motion vectors of the control points according to the affine model. The control points can be set to the corner of the block. For a 6-parameter affine model, three control points are needed and for four parameters affine mode as shown in FIG. 3 (3A shows two control points, 3B shows three control points). To reduce computational complexity of the model computation and the bandwidth of the motion compensation, granularity of affine motion compensation is changed from sample level to the sub-block level. In AVS3 and later, 4×4 or 8×8 luma sub-block affine motion compensation is adopted wherein each 4×4 sub-block or 8×8 sub-block has a motion vector to perform motion compensation. To derive motion vectors of each 8×8 or 4×4 luma sub-block, the motion vector of the center position of each sub-block, as shown in FIG. 3C, is calculated according to two or three control points (“CPs”), and rounded to 1/16 fraction accuracy. Then, motion compensation is performed to generate the prediction of each sub-block with derived motion vectors.

To perform affine motion compensation, there are also two modes: affine inter mode where the motion vector differences of control points and reference index are signaling in the bitstream and affine skip mode and direct mode where the motion vector difference and reference index are not signaled but derived at the decoder side.

For affine skip mode and direct mode, the motion vectors of the control points (“CPMVs”) of the current blocks are generated based on the motion information of the spatial neighboring blocks. There are five candidates in the affine skip mode and direct mode candidate list and an index is signaled to indicate the one to be used for the current block. The affine skip mode and direct mode candidate list consists of the following three types of candidates in order: (1) inherited affine merge candidates where the CPMVs of the current block is extrapolated from the CPMVs of the spatial neighbor blocks; (2) constructed affine merge candidates CPMVs where the CPMVs of the current block is borrowed from translation MVs of the different neighboring blocks; (3) zero motion vectors.

There are a maximum of two inherited affine candidates, which are derived from affine motion model of the neighboring blocks, one from left neighboring blocks and one from above neighboring blocks. When a neighboring affine block is identified, its CPMVs are used to derive the CPMV of the current block. For constructed affine candidate, the CPMVs of the current block is constructed by combining motion information of different neighboring block. After inserting inherited affine candidates and constructed affine candidates into the affine skip mode and direct mode candidate list, if the list is still not full, zero MVs are inserted to until the list is full.

For affine inter mode, the difference of the CPMVs of current block and the index of CPMV predictors (“CPMVPs”) are signaled in the bitstream. An affine flag is signaled in the bitstream to indicate whether affine inter mode is used and then another flag is signaled to indicate whether 4-parameter affine or 6-parameter affine is used if affine inter mode is used. An affine CPMVP candidate list which has 2 candidates is constructed both at the encoder and decoder side. The affine CPMVP candidate list is constructed by using the following four types of CPMVPs candidates in order: 1) inherited affine candidates where the CPMVPs are extrapolated from the CPMVs of the neighbor blocks; 2) constructed affine candidates where CPMVPs are derived from the translational motion vectors of the neighbor blocks; 3) translational motion vectors from neighboring blocks; 4) zero motion vectors.

The index of CPMVP is signaled in the bitstream to indicate which candidate is used as CPMVP for the current block and then the MVD signaled in the bitstream are added to the CPMVP to get the final value of CPMVs of the current block.

Affine motion compensation can only be applied on the block with the size greater than or equal to 16×16.

Instead of explicitly signaling a MVD in the bitstream, decoder side motion vector refinement can be used to refine the motion vector at the decoder side according to symmetrical mechanism. Hence, Decoder side Motion Vector Refinement (“DMVR”) can only apply to the block with bi-prediction. The reference picture list 0 motion vector, MV0, and the reference picture list 1 motion vector, MV1, are derived, and motion vector refinement is performed upon MV0 and MV1.

DMVR is performed based on 16×16 sub-blocks. Before refining the motion vector, MV0 and MV1 are adjusted to integer precision and set as initial MVs. The refinement is based on a search process. The samples used in the DMVR are within a window with size of (block width+7)*(block height+7). As 8-tap interpolation filter is used in normal motion compensation, setting the data window as (block width+7)*(block height+7) will not increase the memory bandwidth. The integer reference samples in the window are fetched from the reference picture of list 0 and list 1. The position on which the sum of difference of the list 0 reference block and list 1 reference block is minimized is set as the optimal integer position.

As shown in FIG. 4, the initial position referenced to by the initial MV0 and MV1 are shown in blue. For each sub-block, 21 integer positions shown as the triangle are searched. A position with the smallest sum of absolute difference (“SAD”) between the two reference blocks among 21 positions in the surrounding (2, −2) range is identified as the optimal integer position.

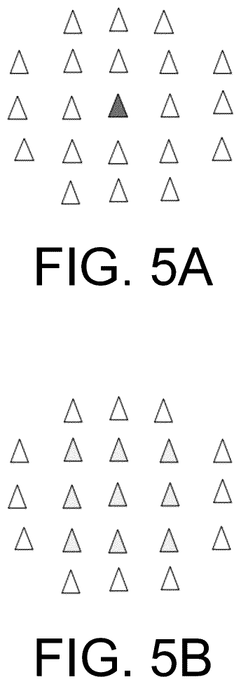

After the integer position search, if the optimal integer position is one of the nine center positions as shown in FIG. 5, sub-pixel estimation is performed. According to SAD values of surrounding integer positions, SAD value of sub-pixel positions are calculated. A least-SAD sub-pixel position is obtained as a refined reference position.

DMVR is applied to skip mode and direct mode, refining motion vectors to improve prediction. DMVR is performed without signaling when the current block meets the following conditions: 1) the current block is a bi-prediction block; 2) the current block is in skip mode or direct mode; 3) the current block does not use the affine mode; 4) the current frame is located between the two reference frames; 5) the distance between the current frame and the two reference frames are the same; 6) the width and height of the current block are greater than or equal to 8.

Bi-directional optical flow (“BIO”) is another way to refine the predicated sample values for the bi-prediction block in skip mode and direct mode.

The traditional bi-prediction performs a weighted average of two reference blocks to obtain the predicted block. BIO further refine the predicted block based on the optical flow theory.

BIO is only applied to bi-prediction. It calculates the gradient values in the horizontal direction and the vertical direction for each sample in the list 0 reference block and list 1 reference block. To calculate the gradient, the current block is divided into 16×16 sub-block as DMVR. A gradient is calculated for the boundary sample of the sub-block by padding the boundary sample of the sub-block rather than sampling the current sub-block. After gradient calculation, the refinement value is calculated for each sample based on the optical flow equation. To reduce computational complexity, it is assumed that each group of 4×4 samples share the same motion vector. Thus, each group has a refinement value. The refinement values are added to the predicted block to get the refined block.

In BIO, the gradient calculation applies an 8-tap interpolation filter, and its filter coefficients are shown in Table 1:

| MV position | coefficients |
|---|---|
| 0 | −4, 11, −39, −1, 41, −14, 8, −2 |
| ¼ | −2, 6, −19, −31, 53, −12, 7, −2 |
| ½ | 0, −1, 0, −50, 50, 0, 1, 0 |
| ¾ | 2, −7, 12, −53, 31, 19, −6, 2 |

There is no flag signaled in bitstream to indicate the use of BIO. BIO is applied for the blocks if all the following conditions are met:
BIO is only applied to luma component;
BIO is only applied to bi-prediction;
The temporally-forward reference frame and the temporally-backward reference frame are on both sides of the current frame; and
The current motion vector accuracy is quarter pixel.

AVS3 and later standards implement inter prediction by template matching, subsequently referred to as “Inter TM.” Inter TM refines the motion vector derived in skip mode and direct mode based on template matching. An AVS3 and later-standard encoder configures one or more processors of a computing system to derive a motion candidate list in skip mode and direct mode, as described above. The first four MV candidates in the list are selected, including one TMVP candidate and three Spatial MVP (“SMVP”) candidates with reference directions setting as bi-prediction, bi-prediction, uni-prediction, and uni-prediction, respectively. The reference information of the four candidates are shown in Table 2.

| Order | 1 | 2 | 3 | 4 |
|---|---|---|---|---|
| Type | TMVP | SMVP | | |
| Reference | List 0 and list 1 | List 0 and list 1 | List 0 | List 1 |
| picture list | | | | |

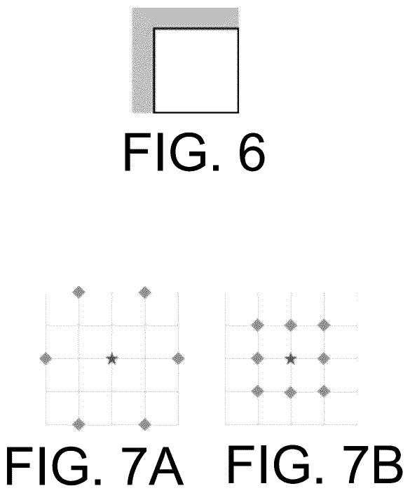

An AVS3 and later-standard encoder configures one or more processors of a computing system to remove duplicates from the MVPs by checking if the two bi-prediction candidates are identical and rounds the MVPs to integer-pixel position. A template (with a width of 4) is constructed using the reconstructed pixels surrounding the current block, and the motion candidate list is sorted such that candidates with smaller template costs are placed at the front. The L-shaped template shape is shown shaded in FIG. 6. The template matching cost is a difference between the template of the current block (which consists of the unshaded reconstructed samples as shown in FIG. 6) and the template of the reference block. The SAD or sum of absolute transformed difference (“SATD”) is used as template matching cost (“TM cost”).

In TM-based MVP refinement, a hexagonal search pattern is used initially, performing up to thirty searches while calculating TM cost by SAD or SATD. The least-TM cost point is selected as the center for the next search iteration, and if the center point is a least-TM cost point in a search iteration, the current hexagonal search terminates. Finally, a square search pattern is used once more to find the best MV. The MV refined by template matching is used as the final MV for the current block and used to generate the prediction block for the current block. The index of the best MVP is encoded into the bitstream using variable-length coding. Square search and hexagonal search are illustrated in FIGS. 7A and 7B respectively. Other search patterns like cross search, diamond search, etc. can also be used. For bi-prediction candidates, MV0 is refined first, followed by MV1, both being refined independently. For uni-prediction candidates, only the available MV is refined, while the unavailable temporal direction is skipped.

As described above, when applying Inter TM, the four candidates are reordered by TM cost, starting with a least-TM cost candidate. Hexagonal and square searches are performed for each candidate, replacing the original MVs with the refined MVs found through the search. Since reordering occurs before search, reordering is based on the original MV instead of the refined MVs that are replaced through the search. The following encoding and decoding processes use the refined MVs. Thus, reordering based on the original MVs and not the refined MVs will introduce inaccuracies to the reordering result.

Furthermore, for bi-prediction candidates, MV0 and MV1 are refined independently by minimizing the reference template referred to by the MV and the current template independently. However, during motion compensation, the final predicted value of the bi-prediction block is obtained by averaging the reference picture list 0 predictor and reference picture list 1 predictor. As a result, independently refining the two MVs may lead to suboptimal results.

Therefore, example embodiments of the present disclosure provide improvements to Inter TM motion refinement. This may be performed by performing a preliminary search before reordering motion candidates of a motion candidate list, adjusting the reordering to be a biased reordering process, altering the candidate list for Inter TM, and/or adjusting TMVP motion vector derivation.

An AVS3 and later-standard encoder and an AVS3 and later-standard decoder according to example embodiments of the present disclosure implement preliminary searching before reordering motion candidates of a motion candidate list.

According to an example embodiment, an AVS3 and later-standard encoder and an AVS3 and later-standard decoder configure one or more processors of a computing system to, before reordering motion candidates of a motion candidate list, update at least some of the motion candidates by performing a respective motion vector refinement by searching to minimize TM costs. The motion candidates of the motion candidate list, at least some of which may be updated by motion vector refinement, are then reordered by least TM cost. After reordering, for any motion candidates not yet updated, a respective motion vector refinement is performed by searching to minimize TM costs.

According to some example embodiments of preliminary searching, searches are performed to update all motion candidates of the motion candidate list by motion vector refinement before reordering the motion candidates of the motion candidate list. The preliminary search includes thirty hexagon searches and one square search to perform motion vector refinement, followed by reordering motion candidates of the motion candidate list after at least some motion candidates are updated by the preliminary search. The template size can be set to four rows above a current block and four columns left of a current block, and the interpolation filter of the reference template can be a 12-tap interpolation filter as the one used in motion compensation or 2-tap interpolation filter for computational complexity reduction.

According to another example embodiment of preliminary searching, one, two, or three hexagon search iterations can be performed before reordering, the reordering can be performed, and then the remaining hexagon searches and one square search can be performed after the reordering. For the template size and interpolation filter taps, one of five possible choices can be made available for use:
1) The template size of both the preliminary search and the subsequent search can be set to four rows above a current block and four columns left of a current block, and the interpolation filter of the reference template can be a 12-tap interpolation filter.
2) The template size of the preliminary search can be set to one row above a current block and one column left of a current block, the template size of the subsequent search can be set to four rows above a current block and four columns left of a current block, and the interpolation filter of the reference template can be a 12-tap interpolation filter.
3) The size of the preliminary search template can be set to one row above a current block and one column left of a current block, and the interpolation filter of the reference template can be a 6-tap interpolation filter with padding. The template size for subsequent searches can be set to four rows above a current block and four columns left of a current block, and the interpolation filter of the reference template can be a 12-tap interpolation filter.
4) The size of the preliminary searched template can be set to one row above a current block and one column left of a current block, and the interpolation filter of the reference template can be a 6-tap interpolation filter without padding. The template size for subsequent searches can be set to four rows above a current block and four columns left of a current block, and the interpolation filter of the reference template can be a 12-tap interpolation filter.
5) The size of the preliminary searched template can be set to one row above a current block and one column left of a current block, and the interpolation filter of the reference template can be a 2-tap interpolation filter. The template size for subsequent searches can be set to four rows above a current block and four columns left of a current block, and the interpolation filter of the reference template can be a 12-tap interpolation filter.

According to another example embodiment of preliminary searching, all the hexagonal searches can be performed before the reordering, and the one square search can be performed after the reordering. The template size of both the preliminary search and the subsequent search can be set to four rows and four columns, and the interpolation filter of the template can use a 12-tap interpolation filter.

An AVS3 and later-standard encoder and an AVS3 and later-standard decoder according to example embodiments of the present disclosure implement prioritized candidate reordering and weighted candidate reordering.

Performing the TM-based preliminary search before candidate reordering can improve reordering accuracy, as it is performed on the MVP candidate with closer value to the final refined MVP. However, this process also increases decoder computational complexity as the decoder needs to perform a preliminary search for all the candidates before performing reordering, then after reordering the decoder can determine the selected candidate according to the index and perform any remaining search only on the selected candidate. Hence, according to a second embodiment, a biased reordering process can be used to reduce decoder computational complexity.

Based on the distribution of the final selection of the MVP candidate after TM-based refinement, the selection of bi-prediction candidates is much higher than that of uni-prediction candidates. Hence, biasing bi-prediction candidates over uni-prediction candidates during reordering can be helpful.

According to an example embodiment of prioritized candidate reordering, an AVS3 and later-standard encoder and an AVS3 and later-standard decoder configure one or more processors of a computing system to sort the first two bi-prediction candidates of a motion candidate list by TM cost, while the two uni-prediction candidates are inserted following the bi-prediction candidates. By doing this, even in the case where the TM cost of uni-prediction is less than a bi-prediction candidate, uni-prediction candidates can still be ordered after bi-prediction candidates.

According to another example embodiment of prioritized candidate reordering, an AVS3 and later-standard encoder and an AVS3 and later-standard decoder configure one or more processors of a computing system to separately sort two bi-prediction candidates and two uni-prediction candidates based on TM cost. Subsequently, the two uni-prediction candidates are inserted following the bi-prediction candidates. In this example, a bi-prediction candidate is ordered against the other bi-prediction candidate and a uni-prediction candidate is ordered against the other uni-prediction candidate. Each prediction direction is ordered by least TM cost, but bi-prediction candidates are always ordered before the uni-prediction candidates, even if the TM costs of the uni-prediction candidates are less than those of bi-prediction candidates.

According to an example embodiment of weighted candidate reordering, the four candidates can be sorted based on TM cost, but the TM costs of uni-prediction candidates can be multiplied by a weight which is greater than 1 (or the TM costs of bi-prediction candidates can be multiplied by a weight which is less than 1) to apply a penalty to the uni-prediction candidate (and/or apply a priority to the bi-prediction candidate, depending on perspective and choice of weight application).

According to some example embodiments, if uni-prediction candidate is more useful than bi-prediction candidate, TM costs of uni-prediction candidates can be multiplied by a weight which is less than 1 (or the TM costs of bi-prediction candidates can be multiplied by a weight which is greater than 1) to apply a priority to the uni-prediction candidate (and/or apply a penalty to the bi-prediction candidate, depending on perspective and choice of weight application).

The weight can be an integer number or a fractional number. Fractional numbers can be represented as MIN, where M is a positive integer number and N is a power of 2, such that the division by N can be implemented by bit right shift operation. That is, MIN is equal to M>>n, where Nis equal to 2″ and >> represents a right bit shift operation. Further, according to some example embodiments, for a bi-prediction candidate having two MVs, a TM cost of the bi-prediction candidate is multiplied by a weight less than 1 or is not multiplied by a weight if the two MVs are not the same, and a TM cost of the bi-prediction candidate is multiplied by a weight greater than 1 (same as a weight for uni-prediction candidates) if the two MVs are the same.

According to another example embodiment of weighted candidate reordering, when the bi-prediction candidate has two reference pictures before the current picture, it is reordered alongside uni-prediction candidates. That is, the example does not give priority to a bi-prediction candidate with two forward reference pictures.

Weight of a uni-prediction candidate can be an integer number like 2, 3, or 4, or can be a decimal number like 1.2, 2.5 or 3.5.

An AVS3 and later-standard encoder and an AVS3 and later-standard decoder can configure one or more processors of a computing system to conditionally apply alternative weights to TM costs of candidates. If reference pictures of the current candidate are before the current picture in display order (i.e., no reference pictures of the current candidate are after the current picture in display order), weight a1 is used for a TM cost of a uni-prediction candidate, and weight a2 is used for a TM cost of a bi-prediction candidate, where a1 can be less than or equal to 1, and a2 can be greater than or equal to 1. If at least one of the reference pictures is after the current picture in display order, weight b1 is used for a TM cost of a uni-prediction candidate, and weight b2 is used for a TM cost of a bi-prediction candidate, where weight b1 can be greater than or equal to 1, and weight b2 can be less than or equal to 1. According to some example embodiments, the weight applied to TM costs in the reordering is dependent on the picture type. For example, weight a can be used for a TM cost of a low-delay picture and weight b can be used for a TM cost of a non-low-delay picture.

An AVS3 and later-standard encoder and an AVS3 and later-standard decoder can configure one or more processors of a computing system to conditionally apply alternative weights to TM costs of low-delay and non-low-delay current pictures. If the current picture is a low-delay picture (i.e., all reference pictures are before the current picture in display order), weight a is used for TM costs of all coding blocks in the current picture. If the current picture is not a low-delay picture (i.e., at least one of the reference pictures is after the current picture in display order), weight b is used for TM costs of all coding blocks in the current picture. Here, weight a can be 1 and weight b can be a real number greater than 1.

According to another example embodiment of weighted candidate reordering, an AVS3 and later-standard encoder configures one or more processors of a computing system to transmit a signaled TM cost weight over a bitstream to an AVS3 and later-standard decoder. A TM cost weight can be signaled in sequence level in sequence header or sequences parameter set. A TM cost weight can also be signaled in picture level in a picture header or a PPS. When a TM cost weight is signaled, in one example, a flag is signaled. An AVS3 and later-standard encoder configures one or more processors of a computing system to select a TM cost weight from two candidate TM cost weights, and signal the corresponding flag value. Depending on the value of the flag, an AVS3 and later-standard decoder configures one or more processors of a computing system to select a TM cost weight for the current picture from two candidate TM cost weights.

According to another example embodiment of weighted candidate reordering, an AVS3 and later-standard encoder configures one or more processors of a computing system to signal an index over a bitstream to an AVS3 and later-standard decoder. The AVS3 and later-standard encoder configures one or more processors of a computing system to select a TM cost weight from multiple candidate TM cost weights, and signal the corresponding flag value in the bitstream. Dependent on the value of the signaled index, an AVS3 and later-standard decoder configures one or more processors of a computing system to select a TM cost weight for a current picture from multiple candidate TM cost weights.

According to another example embodiment of weighted candidate reordering, an AVS3 and later-standard encoder configures one or more processors of a computing system to signal a block-level flag or index over a bitstream to an AVS3 and later-standard decoder. For an Inter TM coding block, a flag or an index is signaled to indicate a TM cost weight, and each block can have different TM cost weights. An AVS3 and later-standard encoder configures one or more processors of a computing system to signal the flag or the index according to a TM cost weight used for the current block. An AVS3 and later-standard decoder configures one or more processors of a computing system to determine a TM cost weight for the current block based on the flag or the index decoded from the bitstream.

According to further example embodiments, preliminary searching and biased reordering are performed in combination. After performing a preliminary search, when performing the reordering, the TM cost for uni-prediction candidates (or bi-prediction candidates) can be multiplied by a weight, according to any example embodiment of weighted candidate reordering as described above.

An AVS3 and later-standard encoder and an AVS3 and later-standard decoder according to example embodiments of the present disclosure implement an Inter TM candidate list including one or more SBTMVP candidates and ETMVP candidates.

As previously discussed, Inter TM candidates include one TMVP candidate and three SMVP candidates. Both SBTMVP and ETMVP belong to skip mode and direct mode. SBTMVP divides a current block into four equal-sized sub-blocks, while ETMVP divides the current block into 8×8 sub-blocks. Each sub-block has its own motion information which is derived from blocks in the collocated picture and performs motion compensation independently.

According to example embodiments of an Inter TM candidate list including SBTMVP candidates and ETMVP candidates, SBTMVP candidates and ETMVP candidates can also be included in the candidate list for Inter TM along with the one TMVP candidate and three SMVP candidates. This allows for hexagonal or square searches on the sub-blocks. During the search process, the same offset can be applied to the MV of each sub-block until a maximum number of searches is reached or an optimal search point is found. Applying the same offset to all sub-blocks can ensure that the boundary between sub-blocks does not have high-frequency residuals.

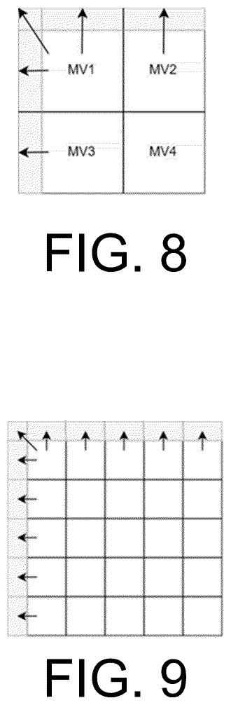

According to an example embodiment of an Inter TM candidate list including SBTMVP candidates and ETMVP candidates, TM-based MVP refinement is performed upon a SBTMVP candidate by performing hexagonal and square searches on each sub-block of the SBTMVP candidate. During the search process a TM cost can be calculated as shown in FIG. 8. The template for a CU can consist of sub-template(s), each of which can be determined by a boundary sub-block. This determination can be performed according to a set of rules such as: 1) for the upper-left boundary sub-block, use its MV to obtain the sub-templates located in one or more rows above the upper-left boundary sub-block, one or more columns left of the upper-left boundary sub-block, and an intersection of the one or more rows and one or more columns upper-left to the upper-left boundary sub-block; 2) for the upper boundary sub-block, use its MV to obtain the sub-template located in one or more rows above the upper-boundary sub-block; 3) for the left boundary sub-block, use its MV to obtain the sub-template located in one or more columns left of the left boundary sub-block. The width and height of the template can be set to 4, 1, or 2. Other search patterns such as cross search, diamond search, etc. can also be used. A 12-tap, 6-tap, or 2-tap interpolation filter can be applied to generate a reference template. Since there is only one SBTMVP candidate, the MVs obtained after the search can be the optimal MVs for each sub-block.

According to another example embodiment of an Inter TM candidate list including SBTMVP candidates and ETMVP candidates, TM-based MVP refinement is performed upon ETMVP candidates by performing hexagonal and square searches on each 8×8 sub-block of the ETMVP candidates, as shown in FIG. 9. The template for the CU (comprising the sub-template(s)) can be obtained as follows: 1) the template above the CU is derived from one or more rows above the uppermost row of 8×8 sub-blocks; 2) the template to the left of the CU is derived from one or more rows left of the leftmost column of 8×8 sub-blocks; 3) the template at the upper-left corner of the CU is derived from an intersection of the one or more rows and one or more columns upper-left to the upper-left 8×8 sub-block. The width and height of the template can be set to 2, 1, or 4. 12-tap, 6-tap, or 2-tap interpolation filter can be applied to generate a reference template. Other search patterns like cross search, diamond search, etc. can also be used. Similar to refinement of a SBTMVP candidate as described above, the same offset can be applied to MVs of all the sub-blocks after refinement.

Since there may be multiple ETMVP candidates, after refinement of each ETMVP candidate, the candidate list can be reordered based on TM cost. The candidate with the smallest TM cost can be placed at the front of the list.

Searches performed to refine ETMVP candidates are similar to searches performed for Inter TM: hexagon and square searches are performed for MV0 and MV1 sequentially, but the number of hexagon search rounds can be adjusted, for example fourteen rounds at most. During motion compensation for each sub-block, DMVR can be applied to bi-predicted sub-blocks that meet the DMVR conditions. This process can be performed either after ETMVP TM, or before ETMVP TM by executing DMVR first.

To reduce computational complexity of a bi-predicted block, in one example, the hexagonal search is replaced by a cross-shaped search, where the search step of the cross search is set to ½-pixel, and the maximum number of search rounds is adjusted accordingly. The hexagonal search pattern has six neighboring positions to be searched in each search round and the cross-shaped search pattern only has four neighboring search positions to be searched in each search round. In further examples, computational complexity of ETMVP TM is reduced by skipping the square search after the hexagonal search, or by removing the reordering step before the search, or by reducing the number of hexagonal search rounds for low-delay (“LD”) frames.

An AVS3 and later-standard encoder and an AVS3 and later-standard decoder according to example embodiments of the present disclosure implement TM-based refinement based on combined reference templates.

According to example embodiments of TM-based refinement based on combined reference templates, when deriving the MV for a TMVP candidate, a determination can be made as to whether the forward MV (MV of reference picture list 0) and backward MV (MV of reference picture list 1) of the collocated block are available.

As FIG. 10A illustrates, if both directional MVs are available, then the forward MV of the collocated block can be used to derive the forward MV of the current block and the backward MV of the collocated block can be used to derive the backward MV of the current block.

As FIGS. 10B and 10C illustrate, if only one directional MV is available, the available directional MV can be used to derive both the forward and backward MVs for the current block.

FIG. 10B illustrates a case where the forward MV of the collocated block is available, but the backward MV is not. In such a case, the forward MV can be used to derive both the forward and backward MVs for the current block.

FIG. 10C illustrates a case where the backward MV of the collocated block is available, but the forward MV is not. In this case, the backward MV is used to derive both the forward and backward MVs for the current block.

If neither the forward nor the backward MVs of the collocated block are available, the MVs for the current block can be filled using default values.

An AVS3 and later-standard encoder and an AVS3 and later-standard decoder according to example embodiments of the present disclosure implement conditional motion vector derivation for TMVP candidates.

For a uni-prediction block, there is only one MV to be refined. Refinement is based on the TM cost which is calculated as the SAD or SATD between the reference template referred to by the MV to be refined and the current template, according to Equation 1 below:

$$TM cost = SAD ( the reference template , the current template )$$

where SAD (A, B) is a function to calculate the SAD or SATD between block A and block B.

For a bi-prediction block, the two MVs can be refined independently. When refining MV0 (the motion vector of reference picture list 0), only the reference template of reference picture list 0 (denoted as reference 0 template) is considered and the TM cost is calculated according to Equation 2 below:

$$TM cost = SAD ( the reference 0 template , the current template )$$

where SAD (A, B) is a function to calculate the SAD or SATD between block A and block B.

When refining MV1 (the motion vector of reference picture list 1), only the reference template of reference picture list 1 (denoted as reference 1 template) is considered and the TM cost is calculated according to Equation 3 below:

$$TM cost = SAD ( the reference 1 template , the current template )$$

where SAD (A, B) is a function to calculate the SAD or SATD between block A and block B.

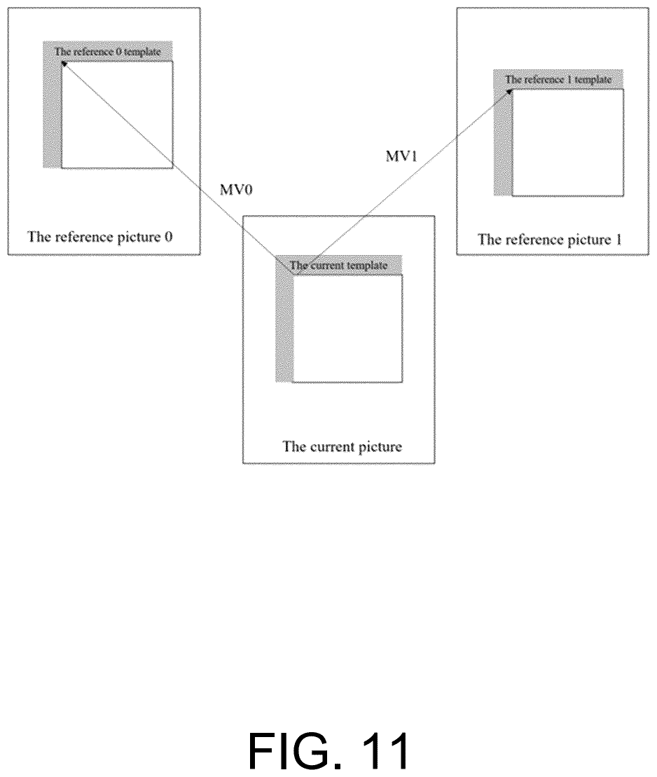

However, TM cost of the final predictor of a bi-predicted block is obtained by weighted averaging the predictor of the reference picture list 0 and reference picture list 1. Thus, to make the refinement more accurate, reference templates from reference picture list 0 and reference picture list 1 are combined when performing TM-based refinement for bi-prediction candidates, as illustrated in FIG. 11. Specifically, during the TM-based refinement for a motion vector, the average of the reference template from reference picture list 0 (denoted as a “reference 0 template”) and reference template from reference picture list 1 (denoted as a “reference 1 template”) are used as the reference template and the TM cost is calculated by comparing an averaged reference template, according to Equation 4 below, to the current template, according to Equation 5 and Equation 6 below:

$$reference template = ( reference 0 template + reference 1 template ) / 2$$

$$TM cost = SAD ( the reference 1 template , the current template )$$

where SAD (A, B) is a function to calculate the SAD or SATD between block A and block B.

To limit computational complexity, MV0 and MV1 are respectively refined while holding the other fixed. To improve computational performance, MV refinement is furthermore iterated: for example, in the first iteration, MV0 is refined and MV1 is fixed. For each search position, a reference 0 template is obtained by the corresponding MV0 and a reference template is obtained by averaging the reference 0 template and the reference 1 template which is fixed (as MV1 is fixed). The MV0 yielding the minimum TM cost between the reference template and the current template is output as the refined MV0 in this iteration.

Then, in the next iteration, the refined MV0 is fixed and MV1 is refined. Similar as the first iteration, for each search position, a reference 1 template is obtained by the corresponding MV1 and a reference template is obtained by averaging the reference 1 template and the reference 0 template which is fixed (as MV0 is fixed). The MV1 yielding the minimum TM cost between the reference template and the current template is output as the refined MV1 in this iteration.

To combine reference 0 template and reference 1 template, the averaging operation of these two reference templates needs to be calculated for each search position. To reduce computational complexity, in some embodiments, TM cost is calculated as the difference between twice of the current template minus the fixed one of the two reference templates and the refined one of the two reference templates. That is, in the MV0 refinement iteration, MV1 is fixed (i.e., reference 0 template is the refined template and reference 1 template is the fixed template) and the TM is calculated according to Equation 7 below:

$$TM cost = SAD ( 2 * the current reference template - the reference 1 template , the reference 0 template )$$

where SAD (A, B) is a function to calculate the SAD or SATD between block A and block B.

In the MV1 refinement iteration, MV0 is fixed (i.e., reference 1 template is the refined template and reference 0 template is the fixed template) and the TM is calculated according to Equation 8 below:

$$TM cost = SAD ( 2 * the current reference template - the reference 0 template , the reference 1 template )$$

where SAD (A, B) is a function to calculate the SAD or SATD between block A and block B.

For brevity, TM refinement based on both a reference 0 template and a reference 1 template is subsequently referred to as “joint refinement” and the search process is referred to as “joint search”, while TM refinement based on only one template is referred to as “independent refinement search” and the search process is referred to as “independent search”.

Independent refinement and joint refinement can be iteratively performed: for example, an independent refinement process to refine MV0 is performed in a first iteration, an independent refinement process to refine MV1 is performed in a second iteration, and a joint refinement process is performed to refine MV0 again in a final iteration. In another example, an independent refinement process is performed to refine MV0 in a first iteration, a joint refinement process is performed to refine MV1 in a second iteration, and a joint refinement process is performed to refine MV0 again in a final iteration.

In some other embodiments, a first-refined MV of a bi-predicted block is determined by TM cost yielded by the initial MV. That is, respective TM costs of initial MV0 and initial MV1 are calculated first according to Equation 9 and Equation 10 below:

$$TM cost 0 = SAD ( the reference 0 template referred to by the initial MV0 , the current template )$$

$$TM cost 1 = SAD ( the reference 1 template referred to by the initial MV1 , the current template )$$

If TM cost 0 is less than TM cost 1, MV0 is refined first, followed by MV1; if TM cost 1 is less than TM cost 0, MV1 is refined first, followed by MV0. Alternatively, if TM cost 1 is greater than TM cost 0, MV1 is refined first, followed by MV0; if TM cost 0 is greater than TM cost 1, MV0 is refined first, followed by MV1.

In one example, independent refinement process is performed in the first iteration. The MV whose initial value yields the smaller TM cost is refined in the first iteration, and the other MV is refined in the second iteration by a joint refinement.

In another example, independent refinement search is performed in the first iteration. The MV whose initial value yields the larger TM cost is refined in the first iteration-assuming MV0, for illustrative purposes. In the second iteration, MV1 is then refined based on the refined value of MV0 by joint refinement. Then, MV0 is refined again based on the refined value of MV1 by joint refinement search.

The search process in a joint refinement can be a full search that includes both hexagon and square search patterns, or it can be a simple cross search. The precision of the cross search can be set to ¼-pixel, ½-pixel, or a combination—for example, starting with ½-pixel precision search rounds, followed by ¼-pixel precision search rounds.

TM refinement process is similar for ETMVP TM and SBTMVP TM. The only difference is that templates for ETMVP and SBTMVP are obtained by using MVs from multiple sub-blocks, rather than by a single MV.

An AVS3 and later-standard encoder and an AVS3 and later-standard decoder according to example embodiments of the present disclosure implement converting a bi-predicted block to a uni-predicted block.

For a bi-predicted block, two MVs are refined and usually an iterative search process is performed. Thus, search complexity is much higher than for a uni-predicted block. Especially for ETMVP, a template consists of sub-templates which are respectively referred to by a boundary sub-MVs, where each sub-template needs to be interpolated for each search position. To reduce computational complexity for a bi-predicted block, the bi-predicted block is converted to a uni-predicted block first, and TM-based refinement for a uni-predicted block is performed.

For example, if the current block is uni-predicted with MV0, no conversion is performed. If the current block is uni-predicted with MV1, it is converted to a uni-predicted block with MV0. The value of MV0 is set to the value of MV1, or the value of MV0 is derived by scaling MV1 based on the POC distance between the reference picture in the reference picture list 0 and the current picture, and the POC distance between the reference picture in the reference picture list 1 and the current picture. The reference index for the reference picture list 0 (i.e., reference index 0) can be directly set to 0 and the reference index for the reference picture list 1 (i.e., reference index 1) can be set to an invalid value.

If the current block is bi-predicted, and MV0 and MV1 refer to the same reference picture (i.e., although they refer to two reference pictures in the two reference picture lists, they are actually the same picture), the current block is converted to a uni-predicted block with only MV0. The value of converted MV0 is set to the averaged value of the original MV0 and MV1 of the bi-predicted block. Reference index 0 is set to the value referring to that same reference picture and reference index 1 is set to an invalid value.

In each case, after conversion, the current block is always uni-predicted with MV0, and TM-based refinement is performed for MV0 only.

For ETMVP mode, the same conversion can be applied: for each sub-block, if a sub-block is uni-predicted with MV0, no conversion is performed. If a sub-block is uni-predicted with MV1, it is converted to a uni-predicted sub-block with MV0. The value of MV0 is set to the value of MV1, or the value of MV0 is derived by scaling MV1 based on the POC distance between the reference picture in the reference picture list 0 and the current picture, and the POC distance between the reference picture in the reference picture list 1 and the current picture. The reference index for reference picture list 0 (i.e., reference index 0) can be directly set to 0 and the reference index for reference picture list 1 (i.e., reference index 1) can be set to an invalid value.

If a sub-block is bi-predicted, and MV0 and MV1 refer to the same reference picture (i.e., although they refer to two reference pictures in the two reference picture lists, they are actually the same picture), the sub-block is converted to a uni-predicted sub-block with only MV0. The value of converted MV0 is set to the averaged value of the original MV0 and MV1 of the bi-predicted sub-block. Reference index 0 is set to the value referring to that same reference picture and reference index 1 is set to an invalid value.

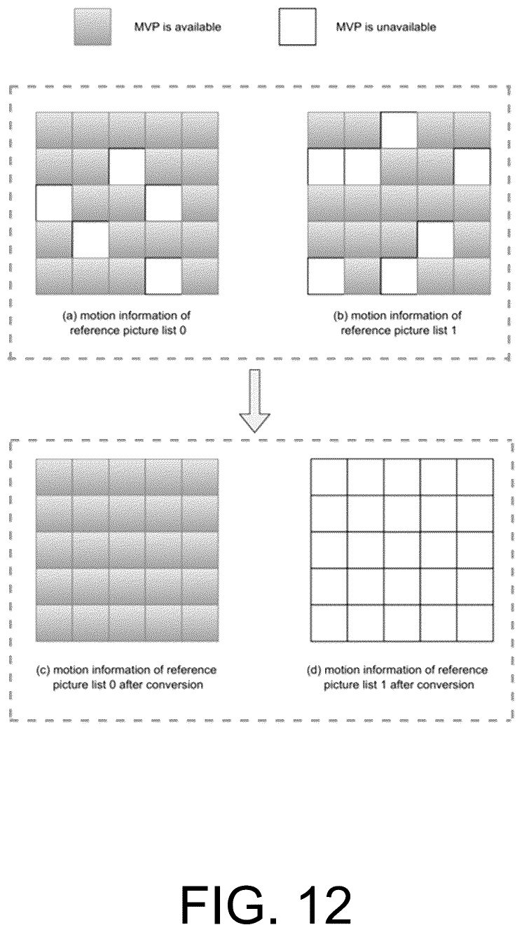

In each case, after conversion, all the sub-blocks within the current coding block are uni-predicted with MV0, as illustrated in FIG. 12. The TM-based refinement for MV1 and motion compensation for reference picture list 1 can be skipped.

Conversion of bi-predicted blocks to uni-predicted blocks can be limited to low-delay pictures, where the reference picture list 0 may be the same as the reference picture list 1 (both reference picture lists only contain the decoded pictures before the current picture in the display order). Thus, there is a high possibility that the MV0 and MV1 refers to a same reference picture for low-delay pictures.

The aforementioned embodiments can be freely combined.

Persons skilled in the art will appreciate that all of the above aspects of the present disclosure may be implemented concurrently in any combination thereof, and all aspects of the present disclosure may be implemented in combination as yet another embodiment of the present disclosure.

FIG. 13 illustrates an example system 1300 for implementing the processes and methods described above for implementing motion vector refinement.

The techniques and mechanisms described herein may be implemented by multiple instances of the system 1300 as well as by any other computing device, system, and/or environment. The system 1300 shown in FIG. 13 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1300 may include one or more processors 1302 and system memory 1304 communicatively coupled to the processor(s) 1302. The processor(s) 1302 may execute one or more modules and/or processes to cause the processor(s) 1302 to perform a variety of functions. In some embodiments, the processor(s) 1302 may include a central processing unit (“CPU”), a graphics processing unit (“GPU”), both CPU and GPU, or other processing units or components known in the art. Additionally, each of the processor(s) 1302 may possess its own local memory, which also may store program modules, program data, and/or one or more operating systems.

Depending on the exact configuration and type of the system 1300, the system memory 1304 may be volatile, such as RAM, non-volatile, such as ROM, flash memory, miniature hard drive, memory card, and the like, or some combination thereof. The system memory 1304 may include one or more computer-executable modules 1306 that are executable by the processor(s) 1302.

The modules 1306 may include, but are not limited to, one or more of an encoder 1308 and a decoder 1310.

The encoder 1308 may be an AVS3 and later-standard encoder implementing any, some, or all aspects of example embodiments of the present disclosure as described above, and executable by the processor(s) 1302 to configure the processor(s) 1302 to perform operations as described above.

The decoder 1310 may be an AVS3 and later-standard encoder implementing any, some, or all aspects of example embodiments of the present disclosure as described above, executable by the processor(s) 1302 to configure the processor(s) 1302 to perform operations as described above.

The system 1300 may additionally include an input/output (“I/O”) interface 1340 for receiving image source data, video data, and bitstream data, and for outputting reconstructed pictures and/or video into a reference picture buffer or DPB and/or a display buffer. The system 1300 may also include a communication module 1350 allowing the system 1300 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 1330, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-12. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
performing motion prediction by inter prediction in skip mode or direct mode;
deriving a motion candidate list comprising a plurality of motion candidates;
reordering the plurality of motion candidates of the motion candidate list by least TM cost, wherein bi-prediction candidates are biased over uni-prediction candidates; and
signaling a coded picture in a bitstream associated with a video sequence.

2. The computing system of claim 1, wherein reordering the plurality of motion candidates of the motion candidate list comprises:
sorting bi-prediction candidates by least TM cost; and
inserting uni-prediction candidates after bi-prediction candidates.

3. The computing system of claim 1, wherein reordering the plurality of motion candidates of the motion candidate list comprises:
sorting bi-prediction candidates by least TM cost;
sorting uni-prediction candidates by least TM cost; and
inserting uni-prediction candidates after bi-prediction candidates.

4. The computing system of claim 1, wherein reordering the plurality of motion candidates of the motion candidate list comprises at least one of:
multiplying each TM cost of a uni-prediction candidate by a weight greater than 1; and
multiplying each TM cost of a bi-prediction candidate by a weight less than 1.

5. The computing system of claim 4, wherein reordering the plurality of motion candidates of the motion candidate list comprises at least one of:
multiplying each TM cost of a bi-prediction candidate by a weight less than 1 unless the bi-prediction candidate comprises two same MVs; and
multiplying each TM cost of a bi-prediction candidate by a weight greater than 1 when the bi-prediction candidate comprises two same MVs.

6. The computing system of claim 1, wherein reordering the plurality of motion candidates of the motion candidate list comprises:
multiplying, by a first weight, a TM cost of a uni-prediction candidate having no reference pictures after the current picture in display order;
multiplying, by a second weight, a TM cost of a bi-prediction candidate having no reference pictures after the current picture in display order;
multiplying, by a third weight, a TM cost of a uni-prediction candidate having a reference picture after the current candidate in display order; and
multiplying, by a fourth weight, a TM cost of a bi-prediction candidate having a reference picture after the current candidate in display order.

7. The computing system of claim 1, wherein reordering the plurality of motion candidates of the motion candidate list comprises:
multiplying, by a first weight, a TM cost of a coding block of a low-delay current picture; and
multiplying, by a second weight, a TM cost of a coding block of a non-low-delay current picture.

8. The computing system of claim 1, wherein the operations further comprise:
multiplying a TM cost of a motion candidate by a TM cost weight; and
signaling the TM cost weight in a picture header in the bitstream.

9. The computing system of claim 1, wherein the operations further comprise:
multiplying a TM cost of a motion candidate by a TM cost weight; and
signaling the TM cost weight in a picture parameter set (“PPS”) in the bitstream.

10. A method, comprising:
decoding a coded picture received in a bitstream associated with a video sequence;
performing motion prediction by inter prediction in skip mode or direct mode;
deriving a motion candidate list comprising a plurality of motion candidates; and
reordering the plurality of motion candidates of the motion candidate list by least TM cost, wherein bi-prediction candidates are biased over uni-prediction candidates.

11. The method of claim 10, wherein reordering the plurality of motion candidates of the motion candidate list comprises:
sorting bi-prediction candidates by least TM cost; and
inserting uni-prediction candidates after bi-prediction candidates.

12. The method of claim 10, wherein reordering the plurality of motion candidates of the motion candidate list comprises:
sorting bi-prediction candidates by least TM cost;
sorting uni-prediction candidates by least TM cost; and
inserting uni-prediction candidates after bi-prediction candidates.

13. The method of claim 10, wherein reordering the plurality of motion candidates of the motion candidate list comprises at least one of:
multiplying each TM cost of a uni-prediction candidate by a weight greater than 1; and
multiplying each TM cost of a bi-prediction candidate by a weight less than 1.

14. The method of claim 13, wherein reordering the plurality of motion candidates of the motion candidate list comprises at least one of:
multiplying each TM cost of a bi-prediction candidate by a weight less than 1 unless the bi-prediction candidate comprises two same MVs; and
multiplying each TM cost of a bi-prediction candidate by a weight greater than 1 when the bi-prediction candidate comprises two same MVs.

15. The method of claim 10, wherein reordering the plurality of motion candidates of the motion candidate list comprises:
multiplying, by a first weight, a TM cost of a uni-prediction candidate having no reference pictures after the current picture in display order;
multiplying, by a second weight, a TM cost of a bi-prediction candidate having no reference pictures after the current picture in display order;
multiplying, by a third weight, a TM cost of a uni-prediction candidate having a reference picture after the current candidate in display order; and
multiplying, by a fourth weight, a TM cost of a bi-prediction candidate having a reference picture after the current candidate in display order.

16. The method of claim 10, wherein reordering the plurality of motion candidates of the motion candidate list comprises:
multiplying, by a first weight, a TM cost of a coding block of a low-delay current picture; and
multiplying, by a second weight, a TM cost of a coding block of a non-low-delay current picture.

17. The method of claim 10, further comprising:
receiving a bitstream associated with a video sequence comprising a TM cost weight in a picture header; and
multiplying a TM cost of a motion candidate by the TM cost weight.

18. The method of claim 10, further comprising:
receiving a bitstream associated with a video sequence comprising a TM cost weight in a picture parameter set (“PPS”); and
multiplying a TM cost of a motion candidate by the TM cost weight.

19. A method of storing a bitstream associated with a video sequence, the method comprising:
generating a bitstream comprising a template matching (“TM”) cost weight by which a TM cost of a motion candidate of a motion candidate list is multiplied; and
storing the bitstream in a non-transitory computer-readable storage medium.

20. The method of claim 19, wherein the TM cost weight is stored in a picture header or stored in a picture parameter set (“PPS”).
